(19) United States
(12) Patent Application Publication
(10) Pub. No.: US 2025/0200270 A1
(43) Pub. Date: Jun. 19, 2025

(54) ELECTRONIC APPARATUS AND METHOD PERFORMED BY THE ELECTRONIC APPARATUS

(71) Applicants: Hyundai Motor Company, Seoul (KR); Kia Corporation, Seoul (KR)

(72) Inventors: Seung Uk Baik, Gunpo-si (KR); Jung Woo Lim, Paju-si (KR); Wan Jae Shin, Yongin-si (KR); Sung Geun Park, Yongin-si (KR)

(21) Appl. No.: 18/786,073

(22) Filed: Jul. 26, 2024

(30) Foreign Application Priority Data
Dec. 13, 2023 (KR) 10-2023-0181222

(51) Int. Cl. G06F 40/166; G06F 40/279

(52) U.S. Cl. CPC G06F 40/166; G06F 40/279

(57) ABSTRACT

An embodiment electronic device includes a processor that obtains a dataset including first data, second data, and third data, obtains a processed dataset including first processed data, second processed data, and third processed data, extracts a first keyword, a second keyword, and a third keyword, selects a first node keyword, a second node keyword, and a third node keyword, identifies a connection relationship between any two node keywords, identifies a non-connection relationship, generates a network including the connection relationship and the non-connection relationship, predicts that the two other node keywords that are unconnected are to be connected based on a similarity between the two other node keywords, and generates output data that includes text about a fusion technology that fuses technologies represented by the two other node keywords based on data included in the dataset and including both of the two other node keywords.

### CROSS-REFERENCE TO RELATED APPLICATIONS

This application claims the benefit of Korean Patent Application No. 10-2023-0181222, filed on Dec. 13, 2023, which application is hereby incorporated herein by reference.

### TECHNICAL FIELD

The present disclosure relates to an electronic device and a method performed by the electronic device.

### BACKGROUND

In recent years, research has been conducted on machine learning techniques that enable computers to generate new content by teaching them data in a manner similar to how humans learn. A device that performs machine learning techniques is able to learn according to empirical data, and then perform predictions based on learned data and improve prediction accuracy. The machine learning techniques may include deep learning techniques.

The deep learning techniques may include various techniques such as deep learning neural networks, convolutional neural networks, and deep belief networks. Deep learning technology is being applied to fields such as computer vision, speech recognition, natural language processing, and voice/signal processing.

In a rapidly changing technological environment, the machine learning techniques such as deep learning may be used to predict future technologies and build appropriate strategies based on those technologies. The machine learning, such as deep learning techniques, may create models to predict non-linear and complex technologies.

### SUMMARY

The present disclosure relates to an electronic device and a method performed by the electronic device. Particular embodiments relate to techniques for generating data including text through machine learning.

Embodiments of the present disclosure can solve problems occurring in the prior art while advantages achieved by the prior art are maintained intact.

An embodiment of the present disclosure provides an electronic device and a method performed by the electronic device which generate text describing a fusion technology that combines multiple technologies based on given data.

An embodiment of the present disclosure provides an electronic device and a method performed by the electronic device which generate text describing fusion technology that combines promising future technologies based on the future technologies.

An embodiment of the present disclosure provides an electronic device and a method performed by the electronic device which select keywords included in given data and identify association between keywords.

An embodiment of the present disclosure provides an electronic device and a method performed by the electronic device which visualize a network between associated keywords among keywords for promising future technologies.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, an electronic device includes one or more processors and storage device storing a program to be executed by the one or more processors, the program including instructions.

According to an embodiment, the processor may obtain a dataset comprising first data including text about a first technology, second data comprising text about a second technology, and third data including text about a third technology, obtain a processed dataset including first processed data obtained based on performing text preprocessing on the first data, second processed data obtained based on performing the text preprocessing on the second data, and third processed data obtained based on performing the text preprocessing on the third data wherein the text preprocessing includes unifying formats of text in the data included in the dataset in a specified format or maintaining words, which are not included in a stopword list, in the text in the data, extract a first keyword representing the first processed data, a second keyword representing the second processed data, and a third keyword representing the third processed data, select a first node keyword based on a first ratio of a first number of pieces of processed data including the first keyword to a total number of pieces of processed data included in the processed dataset exceeding a ratio reference, select a second node keyword based on a second ratio of a second number of pieces of processed data including the second keyword to the total number exceeding the ratio reference, select a third node keyword based on a third ratio of a third number of pieces of processed data including the third keyword to the total number exceeding the ratio reference, identify a connection relationship between any two node keywords based on a fourth ratio of a fourth number of pieces of processed data including text including two of the first to third node keywords to the total number exceeding a common ratio reference, identify a non-connection relationship between two other node keywords based on a fifth ratio of a fifth number of pieces of processed data including text including the two other node keywords of the first to third node keywords to the total number being less than or equal to the common ratio reference, generate a network including the connection relationship and the non-connection relationship, predict that the two other node keywords that are unconnected are to be connected based on a similarity between the two other node keywords, a statistical model, or an association between the two other node keywords identified according to a dimension of the two other node keywords, and generate output data that includes text about a fusion technology that fuses technologies represented by the two other node keywords based on data included in the dataset and including both of the two other node keywords.

According to an embodiment, the processor may perform the text preprocessing based on at least one of unifying upper case or lower case of text contained in one piece of data of the dataset to one of the upper case or the lower case, identifying general text other than special symbols contained in the one piece of data, unifying a language of text contained in the one piece of data, identifying headings for words of the text contained in the one piece of data, or excluding words contained in the stopword list from the text in the one piece of data, or any combination thereof.

According to an embodiment, the processor may extract at least one of the first keyword, the second keyword, or the third keyword, or any combination thereof based on inputting, into a model trained through machine learning, processed data obtained by performing preprocessing on data containing text for the first technology, the second technology, and or the third technology. The model trained through the machine learning may include a bidirectional encoder representations from transformers (BERT) model built with an artificial neural network (ANN).

According to an embodiment, the processor may predict whether the two other node keywords that are not connected are to be connected based on inputting a node keyword selected according to the ratio reference into a model trained through machine learning. The model trained through the machine learning may include a graph neural network (GNN) model built with an artificial neural network.

According to an embodiment, the processor may predict that the two other node keywords that are not connected are to be connected, according to a topology of the network identified based on the network, and according to a keyword embedding vector identified based on the node keywords, configured through a graph convolutional network (GCN) model included in the graph neural network (GNN) model.

According to an embodiment, the processor may identify a document embedding vector obtained by performing embedding on the processed data and a sentence embedding vector obtained by performing embedding on individual sentences of text contained in the processed data, and the processor may extract the first keyword, the second keyword, the third keyword, or any combination thereof, based on a value representing a similarity between the document embedding vector and the sentence embedding vector.

According to an embodiment, the processor may generate the output data including text for the fusion technology based on inputting the other two node keywords that are predicted to be connected to a model trained through machine learning. The model trained through the machine learning may include a large language model (LLM) built with an artificial neural network.

According to an embodiment, the data included in the dataset may comprise a paper, a patent literature, a document describing technology, or any combination thereof.

According to an embodiment, the data included in the dataset may be selected through a survey, an analysis of a group of experts including at least one expert, or any combination thereof.

According to an embodiment, the processor may visually output a connection relationship between the two node keywords, a non-connection relationship between the two other node keywords, and a relationship between the two other node keywords that are unconnected, but predicted to be connected.

According to an embodiment of the present disclosure, a method performed by an electronic device includes obtaining a dataset comprising first data including text about a first technology, second data including text about a second technology, and third data including text about a third technology, obtaining a processed dataset comprising first processed data obtained based on performing text preprocessing on the first data, second processed data obtained based on performing the text preprocessing on the second data, and third processed data obtained based on performing the text preprocessing on the third data, wherein the text preprocessing includes unifying formats of text in the data included in the dataset in a specified format or maintaining words, which are not included in a stopword list, in the text in the data, extracting a first keyword representing the first processed data, a second keyword representing the second processed data, and a third keyword representing the third processed data, selecting a first node keyword based on a first ratio of a first number of pieces of processed data including the first keyword to a total number of pieces of processed data included in the processed dataset exceeding a ratio reference, selecting a second node keyword based on a second ratio of a second number of pieces of processed data including the second keyword to the total number exceeding the ratio reference, selecting a third node keyword based on a third ratio of a third number of pieces of processed data including the third keyword to the total number exceeding the ratio reference, identifying a connection relationship between any two node keywords based on a fourth ratio of a fourth number of pieces of processed data including text including two of the first to third node keywords to the total number exceeding a common ratio reference, identifying a non-connection relationship between two other node keywords based on a fifth ratio of a fifth number of pieces of processed data including text including the two other node keywords of the first to third node keywords to the total number being less than or equal to the common ratio reference, generating a network including the connection relationship and the non-connection relationship, predicting that the two other node keywords that are unconnected are to be connected based on a similarity between the two other node keywords, a statistical model, or an association between the two other node keywords identified according to a dimension of the two other node keywords, and generating output data that includes text about a fusion technology that fuses technologies represented by the two other node keywords based on data included in the dataset and including both of the two other node keywords. The text preprocessing may include unifying formats of text in the data included in the dataset in a specified format or maintaining words, which are not included in a stopword list, in the text in the data.

According to an embodiment, the obtaining of the processed dataset including the first processed data obtained based on performing the text preprocessing on the first data, the second processed data obtained based on performing the text preprocessing on the second data, and the third processed data obtained based on performing the text preprocessing on the third data may comprises performing the text preprocessing based on at least one of unifying upper case or lower case of text contained in one piece of data of the dataset to one of the upper case or the lower case, identifying general text other than special symbols contained in the one piece of data, unifying a language of text contained in the one piece of data, identifying headings for words of the text contained in the one piece of data, excluding words contained in the stopword list from the text in the one piece of data, or any combination thereof.

According to an embodiment, the extracting the first keyword representing the first processed data, the second keyword representing the second processed data, and the third keyword representing the third processed data may comprise extracting at least one of the first keyword, the second keyword, or the third keyword, or any combination thereof based on inputting, into a model trained through machine learning, processed data obtained by performing preprocessing on data containing text for the first technology, the second technology, or the third technology. The model trained through the machine learning may include a bidirectional encoder representations from transformers (BERT) model built with an artificial neural network (ANN).

According to an embodiment, predicting that the two other node keywords that are unconnected are to be connected may comprise predicting whether the two other node keywords that are not connected are to be connected based on inputting a node keyword selected according to the ratio reference into a model trained through machine learning. The model trained through the machine learning may include a graph neural network (GNN) model built with an artificial neural network.

According to an embodiment, the predicting that the two other node keywords that are unconnected are to be connected may comprise predicting that the two other node keywords that are not connected are to be connected, according to a topology of the network identified based on the network, and according to a keyword embedding vector identified based on the node keywords, configured through a graph convolutional network (GCN) model included in the graph neural network (GNN) model.

According to an embodiment, the extracting the first keyword representing the first processed data, the second keyword representing the second processed data, and the third keyword representing the third processed data may comprise identifying a document embedding vector obtained by performing embedding on the processed data and a sentence embedding vector obtained by performing embedding on individual sentences of text contained in the processed data and extracting the first keyword, the second keyword, the third keyword, or any combination thereof, based on a value representing a similarity between the document embedding vector and the sentence embedding vector.

According to an embodiment, generating of the output data that includes the text about the fusion technology may comprise generating the output data including text for the fusion technology based on inputting the other two node keywords that are predicted to be connected to a model trained through machine learning. The model trained through the machine learning may include a large language model (LLM) built with an artificial neural network.

According to an embodiment, the data included in the dataset may comprise a paper, a patent literature, a document describing technology, or any combination thereof.

According to an embodiment, the data included in the dataset may be selected through a survey, an analysis of a group of experts including at least one expert, or any combination thereof.

According to an embodiment, the method may further include visually outputting a connection relationship between the two node keywords, a non-connection relationship between the two other node keywords, and a relationship between the two other node keywords that are unconnected but predicted to be connected.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a block diagram illustrating a configuration of an electronic device according to an embodiment of the present disclosure;

FIG. 2 is another block diagram showing a configuration of an electronic device according to an embodiment of the present disclosure;

FIG. 3 illustrates a flowchart of operation of an electronic device for creating a fusion technology proposal in an electronic device or a method according to one embodiment of the present disclosure;

FIG. 4 illustrates an example diagram depicting a network in an electronic device or a method according to an embodiment of the present disclosure;

FIG. 5 illustrates a flowchart of operation of a model for predicting connections between unconnected node keywords in an electronic device or a method according to an embodiment of the present disclosure;

FIG. 6 illustrates a flowchart of operation of an electronic device for generating output data in an electronic device or a method according to an embodiment of the present disclosure; and

FIG. 7 illustrates a computing system related to an electronic device or a method according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even if it is displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence, or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art and are not to be interpreted as having ideal or excessively formal meanings unless clearly defined as having such in the present application.

In addition, in the present disclosure, the expressions “greater than” or “less than” may be used to indicate whether a specific condition is satisfied or fulfilled, but are used only to indicate examples and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

Embodiments of the present disclosure may predict new fusion technologies by utilizing keyword association prediction models and machine learning techniques.

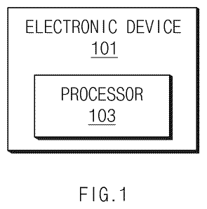

Hereinafter, embodiments of the present disclosure will be described in detail with reference to FIGS. 1 to 7.

FIG. 1 is a block diagram illustrating a configuration of an electronic device according to an embodiment of the present disclosure.

Referring to FIG. 1, an electronic device 101 may include a processor 103. The electronic device 101 and the processor 103 may be electronically and/or operably coupled with each other by an electronic component such as a communication bus.

According to an embodiment, hereinafter, combining pieces of hardware operatively may mean a direct connection or an indirect connection between the pieces of hardware being established in a wired or wireless manner such that first hardware of the pieces of hardware is controlled by second hardware of the pieces of hardware. The type and/or number of hardware components included in the electronic device 101 are not limited to those illustrated in FIG. 1. For example, the electronic device 101 may include only a part of the hardware components illustrated in FIG. 1.

According to an embodiment, the processor 103 of the electronic device 101 may obtain a dataset including text about a technology. For example, the dataset may include first data including text about a first technology, second data including text about a second technology, and third data including text about a third technology. According to an embodiment, data included in the dataset may include text about a future technology selected through at least one of a survey which has been conducted on a group of experts including one or more experts, or an analysis which has been conducted on or by a group of experts, or any combination thereof. According to an embodiment, the experts may be drawn from a variety of fields. According to an embodiment, the data included in the dataset may include at least one of papers, patent literature, or documents describing technology, or any combination thereof. For example, the data included in the dataset may include papers, patent literature, and documents describing technology that have been selected by a group of experts as promising for the future in a particular field (e.g., the mobility industry).

According to an embodiment, the processor 103 of the electronic device 101 may obtain a processed dataset by generating one piece of processed data for each piece of data based on performing text preprocessing on each piece of data included in the dataset. For example, the processor 103 of the electronic device 101 may obtain a processed dataset including first processed data obtained based on performing text preprocessing on first data, second processed data obtained based on performing text preprocessing on second data, and third processed data obtained based on performing text preprocessing on third data.

According to an embodiment, the processor 103 of the electronic device 101 may unify the format of text in data included in the dataset in a specified format or may maintain words, which are not included in a stopword list, in the text in the data.

For example, the processor 103 of the electronic device 101 may perform text preprocessing based on at least one of unifying the upper or lower case of text contained in one piece of data of the dataset to one of the upper or lower case, identifying text excluding special symbols contained in the one piece of data, unifying the language of text contained in the one piece of data, identifying headings for words of the text contained in the one piece of data, or excluding words contained in the stopword list from text in the one piece of data, or any combination thereof. For example, the identifying of headings for words of the text contained in the one piece of data may be referred to as a lemmatization operation, but embodiments of the present disclosure may not be limited thereto. For example, stopwords may be referred to as exclusion words, but embodiments of the present disclosure may not be limited thereto. The stopwords may refer to words in a text whose degree of influence on semantic analysis are less than or equal to a reference level. For example, words such as particles and suffixes may be included as stopwords because their degree of influence on semantic analysis is less than or equal to the reference level.

According to an embodiment, the processor 103 of the electronic device 101 may identify stopwords by referring to a stopword list. The stopword list may be specified by a specific technical field or may be specified by a user. For example, the stopword list may include a stopword list included in Python's natural language toolkit (NLTK) and written in English.

According to an embodiment, the processor 103 of the electronic device 101 may extract at least one keyword representing each piece of processed data included in the processed dataset for each piece of processed data. For example, the processor 103 of the electronic device 101 may extract at least one first keyword representing the first processed data, at least one second keyword representing the second processed data, and at least one third keyword representing the third processed data.

According to an embodiment, the processor 103 of the electronic device 101 may extract a keyword (e.g., first keyword, second keyword, or third keyword) from processed data through bidirectional encoder representations from transformers (BERT), which is a type of model built with an artificial neural network through deep learning techniques.

According to an embodiment, the processor 103 of the electronic device 101 may select one of the keywords to be included in the node keywords based on a ratio of the number of pieces of processed data containing one of at least one keyword representing each piece of processed data to the total number of pieces of processed data included in the processed dataset exceeding a ratio reference. The processor 103 of the electronic device 101 may select a node keyword to exclude, from the node keywords, keywords representing technologies that are tangential or difficult to integrate with other technologies.

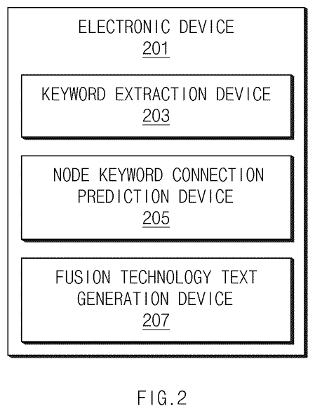

For example, the processor 103 of the electronic device 101 may select a first node keyword based on a ratio of the number of pieces of processed data containing one of the at least one first keyword to the total number of pieces of processed data included in the processed dataset containing the first to third processed data exceeding the ratio reference, select a second node keyword based on the ratio of the number of pieces of processed data containing one of the at least one second keyword to the total number of pieces of processed data exceeding the ratio reference, and select a third node keyword based on the ratio of the number of pieces of processed data containing one of the at least one third keyword to the total number of pieces of processed data exceeding the ratio reference. A specific method for selecting node keywords will be described below with reference to FIG. 2.

According to an embodiment, the processor 103 of the electronic device 101 may identify connection and non-connection relationships between node keywords.

For example, the processor 103 of the electronic device 101 may identify that any two node keywords are connected based on a ratio of the number of pieces of processed data including text including any two of the first to third node keywords to the total number being greater than or equal to a common ratio reference.

For example, the processor 103 of the electronic device 101 may identify that any two node keywords are not connected based on a ratio of the number of pieces of processed data including text including any two of the first to third node keywords to the total number being less than or equal to a common ratio reference.

According to an embodiment, the processor 103 of the electronic device 101 may generate a network including a connection relationship between any two node keywords and a non-connection relationship between any two node keywords. A network may use node keywords as nodes and represent the connection relationship between node keywords as connection lines.

According to an embodiment, the connection lines may be referred to as edges. A ratio of the number of pieces of processed data including text including any two other node keywords among the first to third node keywords to the total number may represent a normalized value of the number of pieces of processed data including text including any two other node keywords among the first to third node keywords together. The processor 103 of the electronic device 101 may identify a connection relationship between node keywords based on association strength. The association strength may include a ratio of the number of pieces of processed data including text including any two other node keywords among the first to third node keywords to the total number.

According to an embodiment, the processor 103 of the electronic device 101 may predict that two other unconnected node keywords are to be connected based on a similarity between the two other node keywords, a statistical model, or an association between the two other node keywords identified according to a dimension of the two other node keywords.

According to an embodiment, the processor 103 of the electronic device 101 may generate output data that includes text about a fusion technology that fuses the technologies represented by the two other node keywords based on the data included in the dataset and including both of the two other node keywords.

FIG. 2 is another block diagram showing a configuration of an electronic device according to an embodiment of the present disclosure.

Referring to FIG. 2, an electronic device 201 may include a keyword extraction device 203, a node keyword connection prediction device 205, and a fusion technology text generation device 207.

According to an embodiment, the keyword extraction device 203 may include a bidirectional encoder representations from transformers (BERT) model, which is a type of model built with an artificial neural network through deep learning techniques.

According to an embodiment, the processor of the electronic device 201 may extract keywords from the processed data through the BERT model. For example, the processor of the electronic device 201 may obtain a document embedding value, which is a vector, by performing embedding on the processed data using the BERT model, or a sentence embedding value, which is a vector, by performing embedding on individual sentences included in the processed data. The processor of the electronic device 201 may obtain a keyword that reveals the topic of a document, based on the vector similarity of the document embedding value and the sentence embedding value. The processor of the electronic device 201 may identify a vector similarity based on a cosine similarity of the document embedding value and the sentence embedding value.

According to an embodiment, a BERT model for keyword extraction may be generated through a transfer learning method that trains a language model built with a language-specific artificial neural network using a large amount of unlabeled data, and then adds a neural network for a specific task based on the pre-trained language model. The BERT-based model may have been trained on a word embedding task in advance. Thus, resources required to train the BERT model to produce a specific result may be less than resources required to train a model which has not been trained in advance to produce a specific result.

According to an embodiment, the node keyword connection prediction device 205 may include a graph neural network (GNN) model, which is a type of model built with an artificial neural network via deep learning techniques.

In an embodiment, the processor of the electronic device 201 may predict which two other unconnected node keywords are to be connected based on a node keyword by using the GNN model. The GNN model may include a graph convolutional network (GCN) model.

For example, the processor of the electronic device 201 may identify the topology of a network through the GCN model and a keyword embedding vector identified based on the node keywords. The processor of the electronic device 201 may predict that any two other node keywords that are not connected are to be connected based on the topology of the network and the node keywords. The processor of the electronic device 201 may improve accuracy based on the keyword embedding value output from the GCN model.

According to an embodiment, the fusion technology text generation device 207 may include a large language model (LLM), which is a type of model built with artificial neural networks through deep learning techniques.

According to an embodiment, the processor of the electronic device 201 may generate output data including text about a fusion technology based on inputting data included in a dataset and including any two node keywords predicted to be connected via an LLM. The text included in the data may include at least one of a title or an abstract of a paper or a combination thereof.

According to an embodiment, the fusion technology text generation device 207 may include a language model capable of making inferences without fine tuning, such as an LLM. The fine tuning may be referred to as additional training. The fusion technology text generation device 207 may include about ten or more times as many parameters (e.g., about 100 billion or more parameters) as traditional language models. The fusion technology text generation device 207 may include an LLM, a language model, or a generative pre-trained transformer (GPT).

According to an embodiment, the processor of the electronic device 201 may obtain output data including text of a suggestion for a fusion technology based on inputting the data into the fusion technology text generation device 207. The output data may include a fusion of a first technology for the first node keyword and a third technology for the third node keyword based on the first node keyword and the third node keyword predicted to be connected.

According to an embodiment, a fusion technology proposal included in the output data may be registered as intellectual property after a review process has been conducted by a group of experts. During the expert group's review process, a proof of concept (POC) may be performed on the fusion technology included in the fusion technology proposal. Because the output data is in the form of sentences rather than keywords, even a person with little background in the field may predict fusion technologies from keywords.

If predicting future technologies to be used in the future through existing electronic devices, there is a limitation that it is only possible to predict technologies that have been learned by the electronic devices, and it is difficult to predict technologies that have not been learned by the electronic devices because it is difficult for the existing electronic devices to derive unlearned information. If predicting future technologies through the insights of a group of experts, there is a limitation that only macro-level predictions are possible, but micro-level predictions are difficult. Predicting future technologies through an electronic device according to an embodiment may solve the limitations of predicting through existing electronic devices and the limitations of predicting through insights from a group of experts.

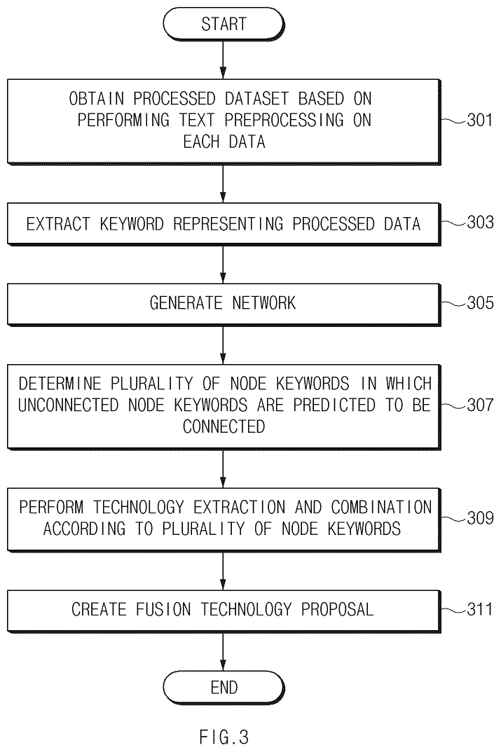

FIG. 3 illustrates a flowchart of operation of an electronic device for creating a fusion technology proposal in an electronic device or a method according to one embodiment of the present disclosure.

Hereinafter, it is assumed that the processor 103 of the electronic device 101 of FIG. 1 performs the process of FIG. 3. Also, in the description of FIG. 3, the operations described as being performed by the processor of the electronic device may be understood as being controlled by the processor 103 of the electronic device 101.

Referring to FIG. 3, in a first operation 301, the processor of the electronic device according to an embodiment may obtain a processed dataset based on performing text preprocessing on each piece of data. Each piece of data may be indicative of data included in the dataset.

In a second operation 303, the processor of the electronic device according to an embodiment may extract keywords indicative of the processed data.

In a third operation 305, the processor of the electronic device according to an embodiment may generate a network.

In a fourth operation 307, the processor of the electronic device according to an embodiment may determine a plurality of node keywords in which unconnected node keywords are predicted to be connected with one another.

In a fifth operation 309, the processor of the electronic device according to an embodiment may perform extraction and combination of technologies based on the plurality of node keywords.

In a sixth operation 311, the processor of the electronic device according to an embodiment may create a fusion technology proposal.

In addition to the fusion technology proposal, the processor of the electronic device may visually output a connection relationship between any two node keywords, a non-connection relationship between any two other node keywords, and a relationship in which any two other unconnected node keywords are predicted to be connected.

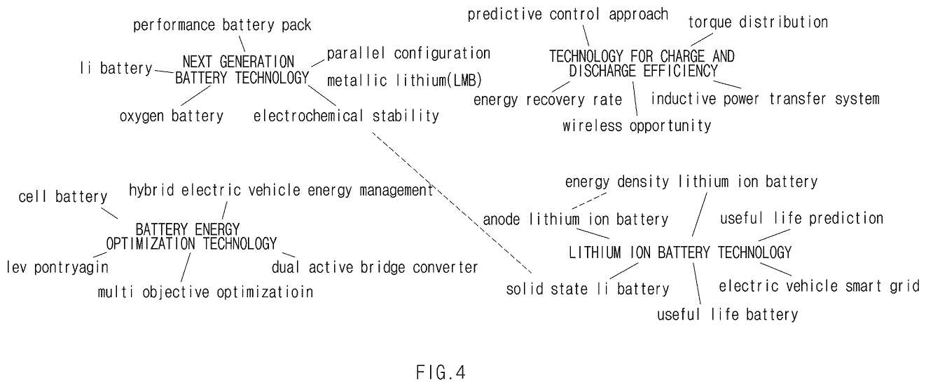

An example of the visual output will be described below with reference to FIG. 4.

FIG. 4 illustrates an example diagram depicting a network, in an electronic device or a method according to an embodiment of the present disclosure.

Referring to FIG. 4, the diagram may represent a visualized or simplified drawing of the network.

According to an embodiment, the processor of the electronic device may obtain, as data, papers and patent literature for technologies that have been selected as future technologies for a particular field (e.g., the mobility industry) through a survey or analysis of a group of experts, and documents describing the technologies. For example, the data may be obtained in such a way that the processor of the electronic device searches a paper retrieval system for words (e.g., electric vehicle, hybrid vehicle, battery electric vehicle, solid state battery) representing the selected technology. The plurality of data obtained may be referred to as a dataset.

According to one embodiment, the processor of the electronic device may obtain a processed dataset from the dataset by performing text preprocessing based on at least one of unifying the upper or lower case of text contained in one piece of data of the dataset to one of the upper or lower case, identifying text excluding special symbols contained in the one piece of data, unifying the language of text contained in the one piece of data, identifying headings for words of the text contained in the one piece of data, or excluding words contained in the stopword list from text in the one piece of data, or any combination thereof.

According to an embodiment, the processor of the electronic device may extract keywords (e.g., predictive control approach, anode lithium ion battery, or electrochemical stability) by inputting the processed dataset into a keyword extraction model based on BERT. Reference may be made to a KeyBERT model as the keyword extraction model based on BERT, but embodiments of the present disclosure may not be limited thereto.

According to an embodiment, the processor of the electronic device may select node keywords (e.g., predictive control approach, anode lithium ion battery, electrochemical stability) from the extracted keywords to exclude keywords that represent technologies that are tangential or difficult to converge with other technologies.

According to an embodiment, the processor of the electronic device may generate a network including a connection relationship and a non-connection relationship between the node keywords.

Further, the processor of the electronic device may include, in the network, a relationship between the node keywords that are predicted to be connected based on a GNN model among the node keywords in the non-connection relationship.

In the diagram, the processor of the electronic device according to an embodiment may visualize node keywords in the connection relationship by connecting the node keywords with connection lines. The processor of the electronic device may visualize node keywords that are not predicted to be connected among node keywords in the non-connection relationship by leaving the connection lines unconnected. The processor of the electronic device may visualize node keywords that are predicted to be connected among node keywords in the non-connection relationship by connecting the node keywords with a different type of connection line (e.g., a solid line) from a type of connection line (e.g., a dashed line) in the connection relationship. For example, a node keyword representing electrochemical stability and a node keyword representing solid state lithium battery may be unconnected, but predicted to be connected. Accordingly, the processor of the electronic device may perform visualization by connecting the node keyword representing electrochemical stability and the node keyword representing solid state lithium battery with a dotted line.

According to an embodiment, the similarity between node keywords classified under a single topic (e.g., next-generation battery technology, battery energy optimization technology, charge/discharge efficiency related technology, lithium-ion battery technology) may be greater than the similarity between node keywords classified under different topics. The topics may be derived by LLM to represent the content of node keywords categorized into the same cluster.

According to an embodiment, the processor of the electronic device may identify data including two node keywords for which a connection is predicted (e.g., vehicle-to-charging station energy cost optimization and resale techniques), but embodiments of the present disclosure may not be limited thereto. According to an embodiment, the processor of the electronic device may identify data including all of node keywords among which connection is predicted.

According to an embodiment, the processor of the electronic device may output output data (e.g., a fusion technology proposal) based on the content of the text of the data including node keywords among which connection is predicted.

According to an embodiment, the processor of the electronic device may obtain the output data by inputting, into the LLM, a command requesting the output data, and a summary of data for technologies to be fused (e.g., a summary for the first technology, a summary for the second technology, and a summary for the third technology).

For example, the command requesting the output data may present as: “As a professional engineer, we propose a new technology concept in the form of a patent that combines the three technologies presented below. It combines the strengths and features of both descriptions and includes claims and a detailed description of the invention.”

For example, a summary of the first technology to be fused may be presented as Table 1.

TABLE 1
Technology 1: Energy conservation and optimization technology in the automotive
industry aims to reduce energy consumption and optimize the use of available energy
sources. This includes developing efficient power management systems and utilizing
regenerative braking to capture energy that would otherwise be lost during braking.
Energy optimization also includes managing the charging and discharging of batteries
in hybrid and electric vehicles to maximize range and efficiency. Smart charging
systems may also be used to optimize energy use between vehicles and charging
stations to reduce energy costs and improve the overall efficiency of the charging
process. Finally, resale technologies allow energy stored in vehicle batteries to be sold
back to the grid during periods of high demand, creating a more sustainable and cost-
effective energy ecosystem.

For example, a summary of the secondary technology to be fused may be presented as Table 2.

TABLE 2
Technology 2: Recently, with the development of artificial intelligence technology,
especially after the great success of AlphaGo, interest in applying RL (Reinforcement
Learning) to solve the EMS (Energy Management Strategy) problem of hybrid electric
vehicles is increasing. However, current problems with RL algorithms, including
deployment inefficiencies, safety constraints, and the simulation-to-reality gap, make
them inapplicable to many industrial EMS tasks. With this in mind, we propose an
offline RL training framework that attempts to extract policies with maximum
possible utility from available offline data, taking into account the fact that there are
many suboptimal EMS controllers capable of generating large amounts of interactive
data containing beneficial behaviors. Furthermore, with the connected vehicle
technology standard in many new cars, a scheduled training framework is proposed
instead of bringing all the data to storage and analysis. This cloud-based approach not
only alleviates the computational burden on edge devices, but also provides a
deployment-efficient solution for EMS tasks that need to adapt to changes in the
driving cycle. To evaluate the validity of the proposed algorithms on real controllers,
hardware-in-the-loop (HIL) tests are performed and the proposed algorithms are
presented: dynamic programming, behavioral replication, rule-based, and vanilla off-
policy RL algorithms.

For example, a summary of the third technology to be fused may be presented as Table 3.

TABLE 3
Technology 3: Extreme-fast charging (XFC) of lithium-ion batteries is critical to the
continued market adoption of electric vehicles. However, mass transport limitations
and slow kinetics lead to lithiation from graphite anodes under fast charge conditions.
One approach to address the mass transfer limitations of graphite is to design
electrodes with low tortuosity to enhance ion transfer. In this study, we developed a
bilayer hybrid structure electrode with directionally aligned channels via freeze tape
casting that enables faster lithium ion diffusion through the graphite electrode. For
simple processing, a scalable roll-to-roll process was designed that allows the slurry
to be cast onto any substrate. Electrochemical impedance spectroscopy
measurements indicate that the bilayer hybrid coating has both low tortuosity and
short diffusion paths that enable XFC charging. Rate tests on the bilayer hybrid
electrode showed superior performance compared to other coatings, with a 0%
improvement in charge capacity over conventional coatings at 5C and 10 minutes
total charge time. The bilayer hybrid electrode also showed a 10% improvement in
capacity retention over the conventional electrode after 1000 cycles under XFC
conditions. This study demonstrates freeze tape casting as a scalable method for
fabricating electrodes with low tortuosity for XFC applications.

According to an embodiment, the processor of the electronic device may obtain output data. The output data may be output in the form of a fusion technology proposal, but embodiments of the present disclosure may not be limited thereto.

For example, the output data may be presented as Table 4. However, the fusion technology proposal listed in Table 4 is an example of output data and may serve as a reference for users to refer to.

TABLE 4
Proposed Technology Name: Method for Optimizing Energy Management of Hybrid
Electric Vehicles and Extreme Fast Charging Technology
Abstract: A method for optimizing the energy management strategy (EMS) problem
of hybrid electric vehicles and extreme fast charging (XFC) technology is presented.
The method includes utilizing a reinforcement learning (RL) algorithm to train offline
policies based on interactive data that includes beneficial behaviors generated by a
suboptimal EMS controller. The method includes using a cloud-based approach to
provide a deployment-efficient solution to EMS tasks that reduce the computational
burden on edge devices and need to adapt to changes in driving cycles. The method
further includes fabricating a bilayer hybrid electrode with directionally aligned
channels via a freeze tape casting process to enable faster lithium ion diffusion
through a graphite electrode.
Proposed Claims:
Proposed Claim 1. A method for optimizing energy management and XFC technology
for a hybrid electric vehicle, the method comprising:
utilizing a reinforcement learning algorithm to train an offline policy based on
interactive data including beneficial behaviors generated by a suboptimal EMS
controller;
using a cloud-based approach to provide a deployment-efficient solution for EMS
tasks that alleviate the computational burden on edge devices and need to adapt to
changes in the driving cycle; and
manufacturing a bilayer hybrid electrode having directionally aligned channels via a
freeze tape casting process to enable faster lithium ion diffusion through a graphite
electrode.
Proposed Claim 2. The method of claim 1, wherein the reinforcement learning
algorithm is configured to use a non-policy approach.
Proposed Claim 3. The method of claim 1, wherein the cloud-based approach is used
to schedule training.
Proposed Claim 4. The method of claim 1, wherein the freeze tape casting process is a
scalable roll-to-roll process.
Proposed Claim 5. A system for optimizing energy management and XFC technology
for a hybrid electric vehicle, comprising:
a reinforcement learning algorithm for training offline policies based on interactive
data including beneficial behaviors generated by a suboptimal EMS controller;
a cloud-based approach for providing a deployment-efficient solution to EMS tasks
that alleviate the computational burden on edge devices and need to adapt to changes
in the driving cycle; and
a bilayer hybrid electrode with directionally aligned channels fabricated via a freeze
tape casting process to enable faster lithium ion diffusion through a graphite
electrode.
Detailed Description of the Proposed Invention:
The present disclosure relates to a method for optimizing energy management and
XFC technology for hybrid electric vehicles. Specifically, the present disclosure
provides a method for optimizing an energy management strategy (EMS) and an
extreme fast charging (XFC) technology for a hybrid electric vehicle. The method
includes utilizing a reinforcement learning (RL) algorithm to train offline policies
based on interactive data that includes beneficial behaviors generated by a
suboptimal EMS controller. The method includes using a cloud-based approach to
provide a deployment-efficient solution to EMS tasks that reduce the computational
burden on edge devices and need to adapt to changes in driving cycles. The method
further includes fabricating a bilayer hybrid electrode with directionally aligned
channels via a freeze tape casting process to enable faster lithium ion diffusion
through a graphite electrode. The method schedules training using an out-of-policy
approach and a cloud-based approach. The freeze tape casting process is a scalable
roll-to-roll process. Therefore, the resulting system provides a more efficient and
cost-effective energy ecosystem.

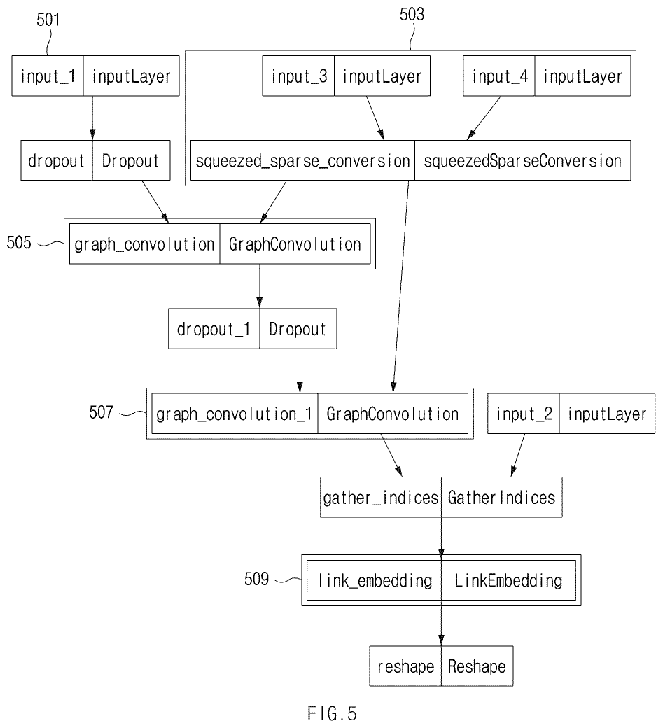

FIG. 5 illustrates a flowchart of operation of a model for predicting connections between unconnected node keywords in an electronic device or a method according to an embodiment of the present disclosure.

Referring to FIG. 5, the operation of a GCN model for predicting unconnected node keywords as being connected will be described.

In a first process 501, the processor of the electronic device may input the embedding matrix of a node keyword obtained through a BERT model into a GCN model.

In a second process 503, the processor of the electronic device may generate an adjacency matrix according to information indicating whether the node keywords are connected with the node keywords.

In a third process 505, the processor of the electronic device may update the embedding matrix of keywords through the adjacency matrix and a weight matrix.

In a fourth process 507, the processor of the electronic device may input into the GCN model two node keywords to determine whether a connection is predicted among unconnected node keywords.

In a fifth process 509, the processor of the electronic device may predict that two node keywords are to be connected if the dot product of updated keyword embedding values is greater than or equal to a specified value (e.g., about 0.5). According to an embodiment, the processor of the electronic device may obtain, from the GCN model, whether a connection between the updated embedding matrix and the unconnected node keywords is predicted by inputting the embedding matrix and the adjacency matrix of the node keywords to the GCN model.

For example, if an output value is a specified number (e.g., 0), a connection between node keywords may not be predicted. If the output value is another specified number (e.g., 1), a connection between node keywords may be predicted.

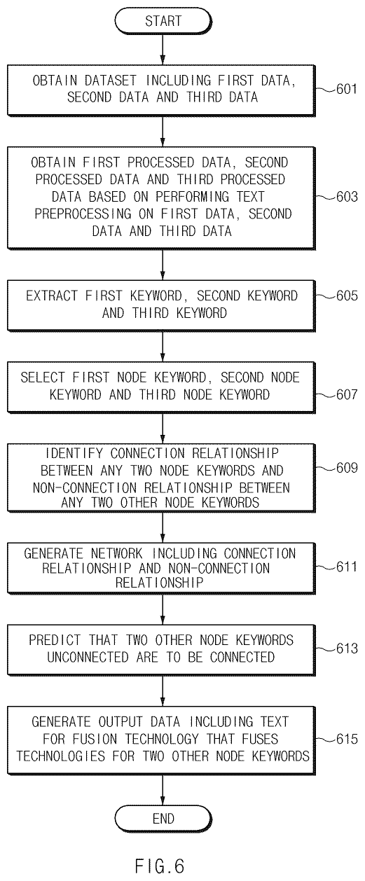

FIG. 6 illustrates a flowchart of operation of an electronic device for generating output data in the electronic device or a method according to an embodiment of the present disclosure.

Hereinafter, it is assumed that the processor 103 of the electronic device 101 of FIG. 1 performs the process of FIG. 6. Also, in the description of FIG. 6, the operations described as being performed by the processor of the electronic device may be understood as being controlled by the processor 103 of the electronic device 101.

Referring to FIG. 6, in a first operation 601, the processor of the electronic device according to an embodiment may obtain a dataset including first data, second data, and third data.

According to an embodiment, the first data may include text about a first technology. The second data may include text about a second technology. The third data may include text about a third technology.

In a second operation 603, the processor of the electronic device according to an embodiment may obtain first processed data, second processed data, and third processed data based on performing text preprocessing on the first data, the second data, and the third data. The first processed data, the second processed data, and the third processed data may be included in the processed dataset.

According to an embodiment, the processor of the electronic device may obtain a processed dataset including first processed data obtained based on performing text preprocessing on first data, second processed data obtained based on performing text preprocessing on second data, and third processed data obtained based on performing text preprocessing on third data.

According to an embodiment, the text preprocessing may include unifying the format of text in data (e.g., first data, second data, and third data) included in the dataset in a specified format or maintaining words, which are not included in a stopword list, in the text in the data. The maintaining of words not included in the stopword list from the text in the data may include removing or excluding words included in the stopword list from the text in the data.

In a third operation 605, the processor of the electronic device according to an embodiment may extract a first keyword, a second keyword, and a third keyword.

According to an embodiment, the first keyword may represent first processed data. The second keyword may represent second processed data. The third keyword may represent third processed data.

In a fourth operation 607, the processor of the electronic device according to an embodiment may select a first node keyword, a second node keyword, and a third node keyword.

According to an embodiment, the processor of the electronic device may select the first node keyword based on a ratio of the number of pieces of processed data including one of at least one first keyword to the total number of pieces of processed data included in the processed dataset being greater than or equal to a ratio reference. The processor of the electronic device may select the second node keyword based on a ratio of the number of pieces of processed data including one of the at least one second keyword to the total number being greater than or equal to the ratio reference. The processor of the electronic device may select the third node keyword based on a ratio of the number of pieces of processed data including one of the at least one third keyword to the total number being greater than or equal to the ratio reference.

In a fifth operation 609, the processor of the electronic device according to an embodiment may identify a connection relationship between any two node keywords and a non-connection relationship between any two node keywords.

According to an embodiment, the processor of the electronic device may identify the connection relationship between any two node keywords based on a ratio of the number of pieces of processed data including text including any two of the first to third node keywords to the total number being greater than or equal to a common ratio reference. The processor of the electronic device may identify the non-connection relationship between any two other node keywords based on a ratio of the number of pieces of processed data including text including any two of the first to third node keywords to the total number being less than or equal to a common ratio reference.

In a sixth operation 611, the processor of the electronic device according to an embodiment may generate a network including a connection relationship and a non-connection relationship.

In a seventh operation 613, the processor of the electronic device according to an embodiment may predict that any two other node keywords that are not connected are to be connected.

According to an embodiment, the processor of the electronic device may predict that two other unconnected node keywords are to be connected based on a similarity between the two other node keywords, a statistical model, or an association between the two other node keywords identified according to a dimension of the two other node keywords.

In an eighth operation 615, the processor of the electronic device according to an embodiment may generate output data including text about a fusion technology that fuses the technologies for any two other node keywords.

According to an embodiment, the processor of the electronic device may generate output data that includes text about a fusion technology that fuses the technologies represented by the two other node keywords based on the data included in the dataset and including both of the two other node keywords.

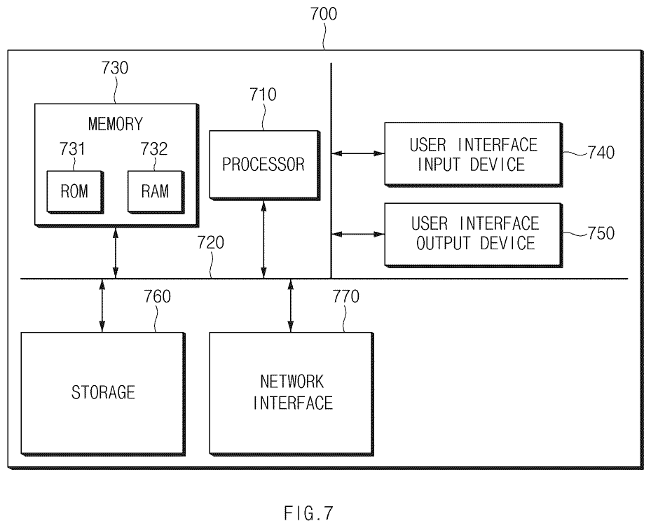

FIG. 7 illustrates a computing system related to an electronic device or a method according to an embodiment of the present disclosure.

Referring to FIG. 7, a computing system 700 may include at least one processor 710, a memory 730, a user interface input device 740, a user interface output device 750, a storage (i.e., a memory) 760, and a network interface 770, which are connected with each other via a bus 720.

The processor 710 may be a central processing unit (CPU) or a semiconductor device that processes instructions stored in the memory 730 and/or the storage 760. The memory 730 and the storage 760 may include various types of volatile or non-volatile storage media. For example, the memory 730 may include a read only memory (ROM) 731 and a random access memory (RAM) 732.

Thus, the operations of the method or the algorithm described in connection with the embodiments disclosed herein may be embodied directly in hardware or a software module executed by the processor 710 or in a combination thereof. The software module may reside on a storage medium (that is, the memory 730 and/or the storage 760) such as a RAM, a flash memory, a ROM, an EPROM, an EEPROM, a register, a hard disk, a removable disk, and a CD-ROM.

The exemplary storage medium may be coupled to the processor 710, and the processor 710 may read information out of the storage medium and may record information in the storage medium. Alternatively, the storage medium may be integrated with the processor 710. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of embodiments of the present disclosure, and various modifications and variations may be made without departing from the essential characteristics of the present disclosure by those skilled in the art to which the present disclosure pertains.

Accordingly, the embodiments disclosed in the present disclosure are not intended to limit the technical idea of the present disclosure but to describe the present disclosure, and the scope of the technical idea of the present disclosure is not limited by the embodiments. The scope of protection of the present disclosure should be interpreted by the following claims, and all technical ideas within the scope equivalent thereto should be construed as being included in the scope of the present disclosure.

The present technology may generate text describing a fusion technology that combines multiple technologies based on given data.

Further, the present technology may generate text describing fusion technology that combines promising future technologies based on promising future technologies.

Further, the present technology may select keywords included in given data and identify association between keywords.

Further, the present technology may visualize a network between associated keywords among keywords for promising future technologies.

In addition, various effects may be provided that are directly or indirectly understood through the disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An electronic device comprising:
one or more processors; and
a storage device storing a program to be executed by the one or more processors, the program including instructions to:
obtain a dataset comprising first data including text about a first technology, second data including text about a second technology, and third data including text about a third technology;
obtain a processed dataset comprising first processed data obtained based on performing text preprocessing on the first data, second processed data obtained based on performing the text preprocessing on the second data, and third processed data obtained based on performing the text preprocessing on the third data, wherein the text preprocessing includes unifying formats of text in the data included in the dataset in a specified format or maintaining words, which are not included in a stopword list, in the text in the data;
extract a first keyword representing the first processed data, a second keyword representing the second processed data, and a third keyword representing the third processed data;
select a first node keyword based on a first ratio of a first number of pieces of processed data including the first keyword to a total number of pieces of processed data included in the processed dataset exceeding a ratio reference;
select a second node keyword based on a second ratio of a second number of pieces of processed data including the second keyword to the total number exceeding the ratio reference;
select a third node keyword based on a third ratio of a third number of pieces of processed data including the third keyword to the total number exceeding the ratio reference;
identify a connection relationship between any two node keywords based on a fourth ratio of a fourth number of pieces of processed data including text including two of the first to third node keywords to the total number exceeding a common ratio reference;
identify a non-connection relationship between two other node keywords based on a fifth ratio of a fifth number of pieces of processed data including text including the two other node keywords of the first to third node keywords to the total number being less than or equal to the common ratio reference;
generate a network including the connection relationship and the non-connection relationship;
predict that the two other node keywords that are unconnected are to be connected based on a similarity between the two other node keywords, a statistical model, or an association between the two other node keywords identified according to a dimension of the two other node keywords; and
generate output data that includes text about a fusion technology that fuses technologies represented by the two other node keywords based on data included in the dataset and including both of the two other node keywords.

2. The electronic device of claim 1, wherein the program further includes instructions to perform the text preprocessing based on unifying upper case or lower case of text contained in one piece of data of the dataset to the upper case or the lower case, identifying general text other than special symbols contained in the one piece of data, unifying a language of text contained in the one piece of data, identifying headings for words of the text contained in the one piece of data, or excluding words contained in the stopword list from the text in the one piece of data, or any combination thereof.

3. The electronic device of claim 1, wherein:
the program further includes instructions to extract at least one of the first keyword, the second keyword, or the third keyword based on inputting, into a model trained through machine learning, processed data obtained by performing preprocessing on data containing text for the first technology, the second technology, or the third technology; and
the model trained through the machine learning includes a bidirectional encoder representations from transformers (BERT) model built with an artificial neural network (ANN).

4. The electronic device of claim 1, wherein:
the program further includes instructions to predict whether the two other node keywords that are not connected are to be connected based on inputting a node keyword selected according to the ratio reference into a model trained through machine learning; and
the model trained through the machine learning includes a graph neural network (GNN) model built with an artificial neural network.

5. The electronic device of claim 4, wherein the program further includes instructions to predict that the two other node keywords that are not connected are to be connected according to a topology of the network identified based on the network and according to a keyword embedding vector identified based on the node keywords configured through a graph convolutional network (GCN) model included in the GNN model.

6. The electronic device of claim 1, wherein the program further includes instructions to:
identify a document embedding vector obtained by performing embedding on the processed data and a sentence embedding vector obtained by performing embedding on individual sentences of text contained in the processed data; and
extract the first keyword, the second keyword, the third keyword, or any combination thereof based on a value representing a similarity between the document embedding vector and the sentence embedding vector.

7. The electronic device of claim 1, wherein:
the program further includes instructions to generate the output data including text for the fusion technology based on inputting the other two node keywords that are predicted to be connected to a model trained through machine learning; and
the model trained through the machine learning includes a large language model (LLM) built with an artificial neural network.

8. The electronic device of claim 1, wherein the data included in the dataset comprises a paper, a patent literature, a document describing technology, or any combination thereof.

9. The electronic device of claim 1, wherein the data included in the dataset is selected through a survey, an analysis of a group of experts including at least one expert, or any combination thereof.

10. The electronic device of claim 1, wherein the program further includes instructions to visually output a connection relationship between the two node keywords, a non-connection relationship between the two other node keywords, and a relationship between the two other node keywords that are unconnected but predicted to be connected.

11. A method performed by an electronic device, the method comprising:
obtaining a dataset comprising first data including text about a first technology, second data including text about a second technology, and third data including text about a third technology;
obtaining a processed dataset comprising first processed data obtained based on performing text preprocessing on the first data, second processed data obtained based on performing the text preprocessing on the second data, and third processed data obtained based on performing the text preprocessing on the third data, wherein the text preprocessing includes unifying formats of text in the data included in the dataset in a specified format or maintaining words, which are not included in a stopword list, in the text in the data;
extracting a first keyword representing the first processed data, a second keyword representing the second processed data, and a third keyword representing the third processed data;
selecting a first node keyword based on a first ratio of a first number of pieces of processed data including the first keyword to a total number of pieces of processed data included in the processed dataset exceeding a ratio reference;
selecting a second node keyword based on a second ratio of a second number of pieces of processed data including the second keyword to the total number exceeding the ratio reference;
selecting a third node keyword based on a third ratio of a third number of pieces of processed data including the third keyword to the total number exceeding the ratio reference;
identifying a connection relationship between any two node keywords based on a fourth ratio of a fourth number of pieces of processed data including text including two of the first to third node keywords to the total number exceeding a common ratio reference;
identifying a non-connection relationship between two other node keywords based on a fifth ratio of a fifth number of pieces of processed data including text including the two other node keywords of the first to third node keywords to the total number being less than or equal to the common ratio reference;
generating a network including the connection relationship and the non-connection relationship;
predicting that the two other node keywords that are unconnected are to be connected based on a similarity between the two other node keywords, a statistical model, or an association between the two other node keywords identified according to a dimension of the two other node keywords; and
generating output data that includes text about a fusion technology that fuses technologies represented by the two other node keywords based on data included in the dataset and including both of the two other node keywords.

12. The method of claim 11, wherein obtaining the processed dataset comprises performing the text preprocessing based on unifying upper case or lower case of text contained in one piece of data of the dataset to the upper case or the lower case, identifying general text other than special symbols contained in the one piece of data, unifying a language of text contained in the one piece of data, identifying headings for words of the text contained in the one piece of data, excluding words contained in the stopword list from the text in the one piece of data, or any combination thereof.

13. The method of claim 11, wherein:
extracting the first keyword representing the first processed data, the second keyword representing the second processed data, and the third keyword representing the third processed data comprises extracting the first keyword, the second keyword, the third keyword, or any combination thereof based on inputting, into a model trained through machine learning, processed data obtained by performing preprocessing on data containing text for the first technology, the second technology, or the third technology; and
the model trained through the machine learning includes a bidirectional encoder representations from transformers (BERT) model built with an artificial neural network (ANN).

14. The method of claim 11, wherein:
predicting that the two other node keywords that are unconnected are to be connected comprises predicting whether the two other node keywords that are not connected are to be connected based on inputting a node keyword selected according to the ratio reference into a model trained through machine learning; and
the model trained through the machine learning includes a graph neural network (GNN) model built with an artificial neural network.

15. The method of claim 14, wherein predicting that the two other node keywords that are unconnected are to be connected comprises predicting that the two other node keywords that are not connected are to be connected according to a topology of the network identified based on the network and according to a keyword embedding vector identified based on the node keywords, configured through a graph convolutional network (GCN) model included in the GNN model.

16. The method of claim 11, wherein extracting the first keyword representing the first processed data, the second keyword representing the second processed data, and the third keyword representing the third processed data comprises:
identifying a document embedding vector obtained by performing embedding on the processed data and a sentence embedding vector obtained by performing embedding on individual sentences of text contained in the processed data; and
extracting the first keyword, the second keyword, the third keyword, or any combination thereof based on a value representing a similarity between the document embedding vector and the sentence embedding vector.

17. The method of claim 11, wherein:
generating the output data that includes the text about the fusion technology comprises generating the output data including text for the fusion technology based on inputting the other two node keywords that are predicted to be connected to a model trained through machine learning; and
the model trained through the machine learning includes a large language model (LLM) built with an artificial neural network.

18. The method of claim 11, wherein the data included in the dataset comprises a paper, a patent literature, a document describing technology, or any combination thereof.

19. The method of claim 11, wherein the data included in the dataset is selected through a survey, an analysis of a group of experts including at least one expert, or any combination thereof.

20. The method of claim 11, further comprising visually outputting a connection relationship between the two node keywords, a non-connection relationship between the two other node keywords, and a relationship between the two other node keywords that are unconnected but predicted to be connected.
